(19) United States
(12) Patent Application Publication
(10) Pub. No.: US 2018/0099691 A1
(43) Pub. Date: Apr. 12, 2018

(54) ELECTRIC POWER STEERING CONTROL METHOD

(71) Applicants: Hyundai Motor Company, Seoul (KR); Kia Motors Corporation, Seoul (KR)

(72) Inventor: Chan Jung KIM, Whasung-Si (KR)

(73) Assignees: Hyundai Motor Company, Seoul (KR); Kia Motors Corporation, Seoul (KR)

(21) Appl. No.: 15/716,282

(22) Filed: Sep. 26, 2017

(30) Foreign Application Priority Data
Oct. 6, 2016 (KR) 10-2016-0128795

(51) Int. Cl. B62D 5/04

(52) U.S. Cl. CPC B62D 5/0466

(57) ABSTRACT

A method for controlling electric power steering in which target steering torque is detected by estimating rack force in response to a turn of a steering wheel and compensation control of steering torque is performed by determining a compensation current value corresponding to the target steering torque, may include a first operation in which actual rack force, generated in response to the turn of the steering wheel, is detected; a second operation in which a position of the steering wheel is detected and on-center rack force is detected in a corresponding portion when a steering angle falls within a scope of a predetermined on-center section; and a third step in which improved on-center rack force is estimated by combining the actual rack force and the on-center rack force and the improved on-center rack force is used to detect the target steering torque.

### CROSS-REFERENCE(S) TO RELATED APPLICATIONS

The present application claims priority to Korean Patent Application No. 10-2016-0128795, filed on Oct. 6, 2016, the entire contents of which are incorporated herein for all purposes by this reference.

### BACKGROUND OF THE INVENTION

### Field of the Invention

The present invention relates to an electric power steering control method. More particularly, the present invention relates to an electric power steering control method, which performs control by improving a rack force when a steering wheel is on-center.

### Description of Related Art

Generally, a steering device of a vehicle is a device for changing a direction in which the vehicle is to move to a desired direction. The steering device changes a pivot around which front wheels of the vehicle turn, and enables the vehicle to proceed in the desired direction.

Power-assisted steering for the above augments power applied to steering effort using a booster when a driver turns a steering wheel of a vehicle, wherein the driver may easily steer the vehicle with less effort.

Such power-assisted steering is largely categorized into Hydraulic Power Steering (HPS) and Electric Power Steering (EPS).

Here, EPS is configured such that an ECU regulates the amount of current flowing through a solenoid valve via a duty controller depending on a vehicle speed signal and a throttle valve-opening rate signal, respectively delivered from a vehicle speed detector and a Throttle Position Sensor (TPS), and the solenoid valve, operating depending on the regulated amount of current, causes a change in steering effort.

That is, EPS is a system for realizing optimum steering feel and feedback by receiving a vehicle speed signal and then performing Pulse Width Modulation (PWM) control of the solenoid valve depending on the vehicle speed.

Meanwhile, rack force is an important factor in the steering performance of the EPS, and hardly changes in response to a minute turn of a steering wheel (0 to 5 degrees). Accordingly, when steering is finely adjusted in control logic based on rack force, a driver may experience a dead-band zone (in which the driver turns a steering wheel but cannot feel the change of torque), which may adversely affect the steering performance.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an electric power steering control method, configured to enhance steering performance by improving on-center rack force, which is a rack force in a state in which a steering wheel is on-center, through an operation on the on-center rack force and existing rack force, facilitating a driver to feel a change of torque in response to a minute turn of the steering wheel.

Various aspects of the present invention are directed to providing a method for controlling electric power steering, in which target steering torque is detected by determining rack force in response to a turn of a steering wheel and compensation control of steering torque is performed by determining a compensation current value corresponding to the target steering torque, the method including a first operation for detecting actual rack force generated in response to the turn of the steering wheel; a second operation for detecting a position of the steering wheel and detecting on-center rack force in a corresponding portion when a steering angle falls within a scope of a predetermined on-center section; and a third operation for determining improved on-center rack force by combining the actual rack force and the on-center rack force and for using the improved on-center rack force to detect the target steering torque.

In an exemplary embodiment, the on-center rack force is detected by multiplying a value of the steering angle, generated in response to the turn of the steering wheel, by a predetermined gain value to simulate the actual rack force in the on-center section.

In another exemplary embodiment, the third operation is configured wherein as the actual rack force and the on-center rack force are combined, when the steering angle of the steering wheel falls within the scope of the predetermined on-center section, the on-center rack force is used to detect the target steering torque.

In still another exemplary embodiment, the third operation is configured wherein as the actual rack force and the on-center rack force are combined, when the steering angle of the steering wheel falls out of the scope of the predetermined on-center section, the actual rack force is used to detect the target steering torque.

In yet another exemplary embodiment, the second operation is configured wherein the on-center portion is predetermined to a range of a steering angle that is 0 to approximately 5 degrees, in which the actual rack force is not generated even though the steering wheel is turned.

Other aspects and exemplary embodiments of the invention are discussed infra.

It is understood that the term “vehicle” or “vehicular” or other similar term as used herein is inclusive of motor vehicles in general including passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The method and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view that sequentially shows an electric power steering control method according to an exemplary embodiment of the present invention;

FIG. 2 is a view that schematically shows control logic for an electric power steering control method according to an exemplary embodiment of the present invention;

FIG. 3 is a view that shows control logic for the third step of an electric power steering control method according to an exemplary embodiment of the present invention;

FIG. 4 is a graph that shows a target steering torque map for an electric power steering control method according to an exemplary embodiment of the present invention;

FIG. 5 is a view that shows control logic for a general electric power steering control method; and

FIG. 6 is a graph that shows rack force depending on a steering angle in an electric power steering control method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

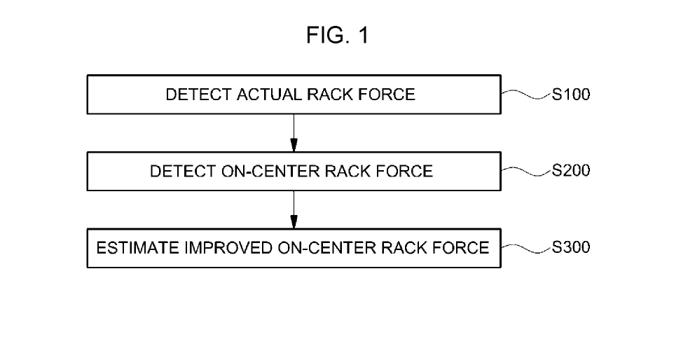

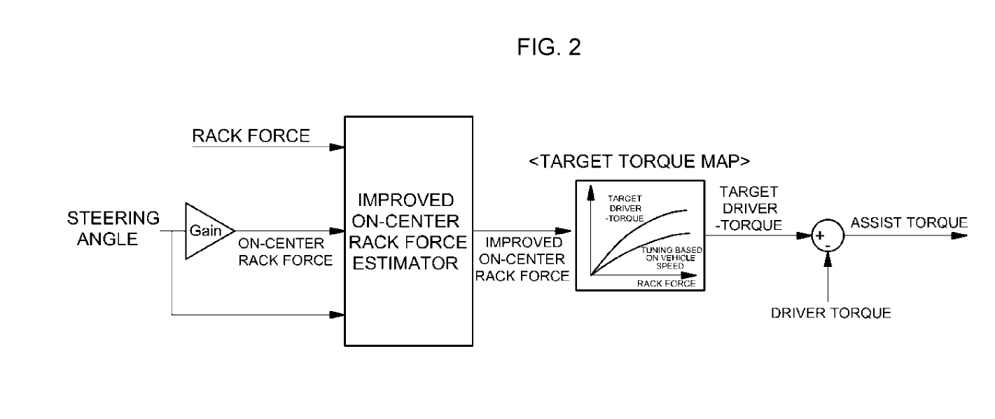

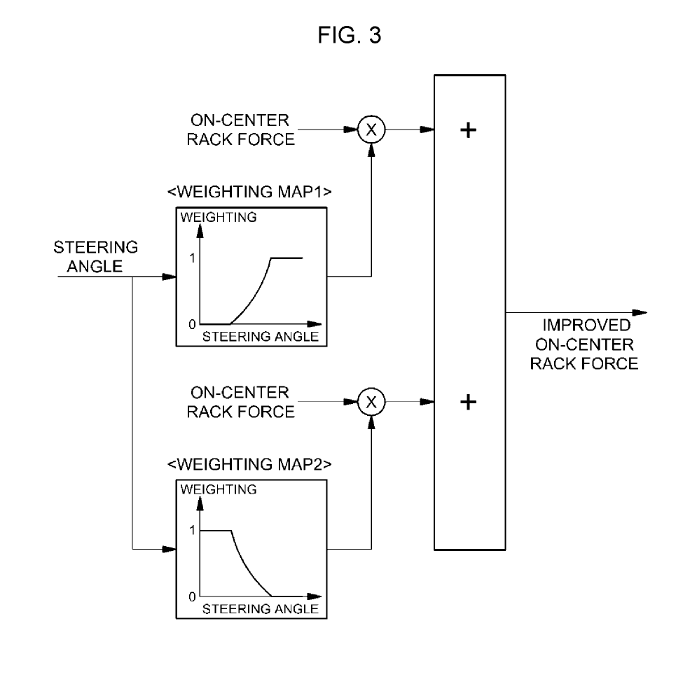

FIG. 1 is a view that sequentially shows an electric power steering control method according to an exemplary embodiment of the present invention, FIG. 2 is a view that schematically shows control logic for an electric power steering control method according to an exemplary embodiment of the present invention, and FIG. 3 is a view that shows control logic for the third step of an electric power steering control method according to an exemplary embodiment of the present invention.

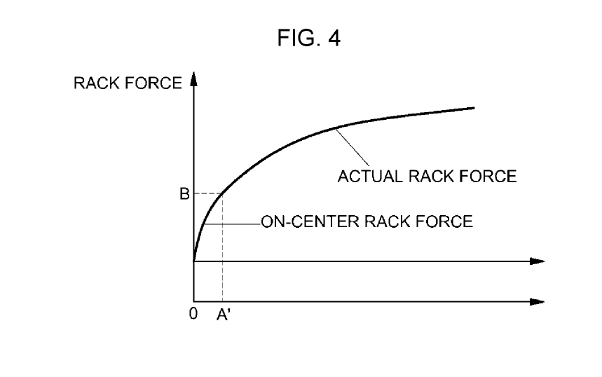

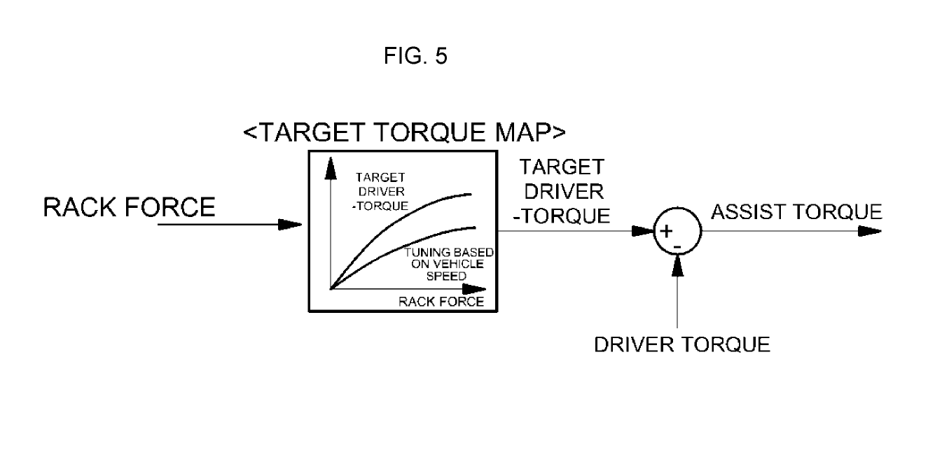

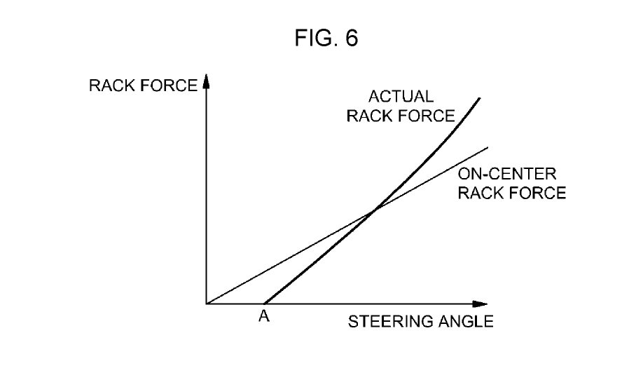

FIG. 4 is a graph that shows a target steering torque map for an electric power steering control method according to an exemplary embodiment of the present invention, FIG. 5 is a view that shows control logic for a general electric power steering control method, and FIG. 6 is a graph that shows rack force depending on a steering angle in an electric power steering control method according to an exemplary embodiment of the present invention.

As shown in FIG. 5, a general electric power steering control method is configured wherein target steering torque is detected by estimating rack force depending on the turn of a steering wheel, driver torque and assist torque are determined using a compensation current value corresponding to the target steering torque, and compensation control of steering torque is performed.

However, in the general electric power steering control method configured as described above, when a steering wheel is turned very slightly, because steering does not immediately cause twisting of tires, that is, rack force hardly changes, a driver may experience a dead-band zone in which there is no change in torque (the driver turns a steering wheel but cannot feel the change of torque), which may adversely affect the steering performance.

That is, as shown in FIG. 6, when a steering wheel is slightly turned (the portion ranging from 0 to A), the actual rack force maintains 0, and the target steering torque does not change in the corresponding section. As a result, although a driver turns a steering wheel in a narrow range, the driver cannot feel the change of torque.

In the present embodiment, on-center rack force, detected when a steering wheel is on-center, is used in place of actual rack force, wherein a driver may feel the change of torque even when slightly turning a steering wheel.

That is, in the present embodiment, actual rack force, used to detect target steering torque, is estimated, and furthermore, the actual rack force and on-center rack force are combined using an improved on-center rack force estimator, and improved on-center rack force detected through the present combination may be used to detect target steering torque, as shown in FIG. 2.

To the present end, first, actual rack force generated by turning a steering wheel is detected at step S100, as shown in FIG. 1.

As such, the position of the steering wheel is detected, and when it is determined that a steering angle falls within the scope of a predetermined on-center section, on-center rack force in the on-center portion is detected at step S200.

The on-center portion may be determined to a steering range in which a steering wheel is turned, but actual rack force is not generated due to a minute turn of the steering wheel, that is, in which the steering angle of the steering wheel is 0 to 5 degrees.

The on-center rack force is used only in the predetermined on-center section, that is, in response to a minute steering angle (0 to 5 degrees), and may be detected by multiplying a steering angle value, generated when the steering wheel is turned, by a predetermined gain value, as shown in FIG. 2, to simulate the actual rack force in the on-center section.

F_{rckv}=Eₐᵣₘ·(Ca+Pneu)·C_{f}·a_{f} <Equation>

F_{rckv}: rack force

Eₐᵣₘ: effective arm

Ca: caster trail

Pneu: pneumatic trail

C_{f}: cornering force

α_{f}: sleep angle

Rack force may be defined as shown in the above equation, and the present equation may be simplified to F_{rckv}=L*θ_{SW}. Accordingly, a value obtained by multiplying a steering angle by a gain value, which is a constant value, may be used as rack force.

In other words, on-center rack force is an arbitrary value for delivering the change of torque to a driver even when the driver slightly turns a steering wheel, and may be detected by multiplying a steering angle, ranging between 0 to 5 degrees, by a corresponding predetermined gain value to enable the on-center rack force to change linearly depending on the steering angle that changes in a range between 0 to about 5 degrees.

Actual rack force is not detected in the portion between 0 to A′ in FIG. 4 due to a minute turn of a steering wheel, but is suddenly generated when passing A′. Accordingly, when on-center rack force is used in place of actual rack force in the portion between 0 to A′, target steering torque changes from 0 to B, wherein a driver may feel the change of torque even when slightly turning the steering wheel.

In the present embodiment, improved on-center rack force is estimated by combining the detected actual rack force and on-center rack force using an improved on-center rack force estimator illustrated in FIG. 2, and the improved on-center rack force is used to detect target steering torque at step S300.

Here, the improved on-center rack force estimator is configured wherein, as the actual rack force and the on-center rack force are combined, when the steering angle of a steering wheel falls within the scope of the predetermined on-center section, the on-center rack force is used to detect target steering torque, as shown in FIG. 3.

That is, when it is determined that the steering angle of a steering wheel falls within the range from approximately 0 to approximately 5 degrees, corresponding to the on-center portion predetermined in the present embodiment, a weight for the on-center rack force is set to 1, as shown in <weighting map 2> in FIG. 3, and at the same time, a weight for the actual rack force is set to 0, wherein the on-center rack force is used to detect target steering torque.

The improved on-center rack force estimator is configured wherein, as the actual rack force and the on-center rack force are combined, when the steering angle of a steering wheel falls out of the scope of the predetermined on-center section, that is, when the steering angle is equal to or greater than approximately 5 degrees, the actual rack force is used to estimate target steering torque, as shown in FIG. 3.

That is, when it is determined that the steering angle of a steering wheel falls out of the range from 0 to 5 degrees, corresponding to the on-center portion predetermined in the present embodiment, a weight for the on-center rack force is set to 0, as shown in <weighting map 1> in FIG. 3, and a weight for the actual rack force is set to 1, wherein the actual rack force is used to detect target steering torque.

For example, assuming that a driver turns a steering wheel in any one direction, the exact time of turning the steering wheel corresponds to an on-center portion in the present embodiment. Therefore, on-center rack force, detected by multiplying a steering angle by a gain value, is used to detect target steering torque, wherein a driver is enabled to feel the change of torque in response to a minute turn of the steering wheel.

As such, as the steering wheel is continuously turned in the same direction, when the steering angle thereof falls out of the scope of the on-center section, target steering torque is detected using the actual rack force rather than the on-center rack force because the on-center rack force is an arbitrary value for facilitating the driver to feel the change of torque.

Consequently, in the present embodiment, when a steering wheel is turned, on-center rack force is detected in the on-center section, but with the continuous turn of the steering wheel, the on-center rack force decreases, and thus control to which actual rack force is applied is performed, wherein a driver is enabled to detect the change of torque in response to a minute turn of the steering wheel and effective steering may be realized.

The present invention improves on-center rack force, which is rack force in a state in which a steering wheel is on-center, through an operation on the on-center rack force and existing rack force, and enables a driver to feel the change of torque when the steering wheel is slightly turned, wherein steering performance may be enhanced.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures. The foregoing description of specific exemplary embodiments of the present invention has been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling electric power steering, in which target steering torque is detected by estimating a rack force in response to a turn of a steering wheel and compensation control of steering torque is performed by determining a compensation current value corresponding to the target steering torque, the method comprising:
a first operation for detecting a rack force, generated in response to the turn of the steering wheel;
a second operation for detecting a position of the steering wheel and detecting on-center rack force in a corresponding portion when a steering angle falls within a scope of a predetermined on-center section; and
a third operation for estimating an improved on-center rack force by combining the detected rack force and the on-center rack force and for using the improved on-center rack force to detect the target steering torque.

2. The method of claim 1, wherein the on-center rack force is detected by multiplying a value of the steering angle, generated in response to the turn of the steering wheel, by a predetermined gain value to simulate the detected rack force in the on-center section.

3. The method of claim 1, wherein the third operation is configured such that when the detected rack force and the on-center rack force are combined while the steering angle of the steering wheel falls within the scope of the predetermined on-center section, the on-center rack force is used to detect the target steering torque.

4. The method of claim 1, wherein the third operation is configured such that when the detected rack force and the on-center rack force are combined while the steering angle of the steering wheel falls out of the scope of the predetermined on-center section, the detected rack force is used to detect the target steering torque.

5. The method of claim 1, wherein the second operation is configured such that the on-center portion is predetermined to a range of a steering angle that is 0 to about 5 degrees, in which the detected rack force is not generated even though the steering wheel is turned.
